(19) United States
(12) Patent Application Publication
(10) Pub. No.: US 2017/0285249 A1
(43) Pub. Date: Oct. 5, 2017

(54) SCREEN PRINTING STENCIL, LIGHT GUIDE PLATE, DISPLAY DEVICE , AND METHOD FOR MANUFACTURING LIGHT GUIDE PLATE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Qiaowei Chong, Tianjin (CN)

(21) Appl. No.: 15/242,481

(22) Filed: Aug. 19, 2016

Related U.S. Application Data
(63) Continuation of application No. PCT/CN2016/088976, filed on Jul. 6, 2016.

(30) Foreign Application Priority Data
Mar. 30, 2016 (CN) 201610195632.7

(51) Int. Cl. F21V 8/00; B41F 15/34; B05D 1/32

(52) U.S. Cl. CPC G02B 6/0065; B05D 1/32; B41F 15/34

(57) ABSTRACT

Disclosed are a screen printing stencil, a light guide plate and a display device. The screen printing stencil includes a pattern printing section arranged corresponding to a light guide plate to be printed, and at least one positioning mark hole arranged on the periphery of the pattern printing section. The light guide plate is manufactured using the screen printing stencil according to the embodiment of the invention by firstly aligning in position the pattern printing section of the screen printing stencil with the light guide plate to be printed, using the at least one positioning mark hole, and then printing on the light guide plate to be printed. A corresponding pattern of positioning marks is printed on the light guide plate in addition to the corresponding pattern. As compared with the prior art, the precision of aligning in position the screen printing stencil with the light guide plate to be printed can be improved to thereby improve the displaying quality of the display product.

This application is a continuation of International Application No. PCT/CN2016/088976, filed on Jul. 6, 2016, which is based upon and claims the benefit of Chinese Patent Application No. 201610195632.7, filed with the Chinese Patent Office on Mar. 30, 2016 and entitled “Screen printing stencil, light guide plate, display device, and method for manufacturing light guide plate”, which is hereby incorporated by reference in its entirety.

### TECHNICAL FIELD

The disclosure relates to the field of display technologies, and particularly to a screen printing stencil, a light guide plate, a display device, and a method for manufacturing a light guide plate.

### BACKGROUND

Among flat panel display devices, Thin Film Transistor Liquid Crystal Displays (TFT-LCDs) have become predominant in the existing market of flat panel displays due to their small volume, low power consumption, low manufacturing cost, no radiation, and other characteristics.

A backlight module is one of key components in the TFT-LCD. The operating principle of the backlight module is to convert a point light source or a line light source into a surface light source with high brightness and good uniformity so that an image can be displayed normally on a liquid crystal panel. The backlight module typically includes in structure a back plate, a light source, a reflection sheet, a light guide plate, an optical film, a glue frame, etc.

The light guide plate is a primary optical component of the backlight module, and is provided with optical pattern distributed on its surface proximate to the back plate, and the optical pattern can diffusely reflect light rays emitted by the light source so that the light rays can exit uniformly the surface of the light guide plate away from the back plate. The optical pattern on the light guide plate is typically formed in a screen printing process using a screen printing stencil.

The inventors have identified during making of the invention at least the following problem in the prior art: it may be so difficult to position the screen printing stencil with respect to the light guide plate to be printed in the traditional process of printing on the light guide plate that if they are positioned inaccurately, then an optical characteristic of display product, and the quality of a picture on the display product will be degraded directly.

### SUMMARY

Embodiments of the invention provide a screen printing stencil, a light guide plate, a display device, and a method for manufacturing a light guide plate so as to improve the precision of aligning in position the screen printing stencil with a light guide plate to be printed to thereby improve the displaying quality of the display product.

According to a first aspect, the present invention provides a screen printing stencil, including a pattern printing section arranged corresponding to a light guide plate to be printed, and at least one positioning mark hole arranged on the periphery of the pattern printing section.

According to a second aspect, the present invention further provides a light guide plate manufactured using the screen printing stencil according to any one of the technical solutions above. Since the light guide plate being printed thereon is aligned in position precisely with the screen printing stencil, the light guide plate will have a high optical quality. Moreover the positioning mark pattern on the light guide plate can be observed to thereby determine whether the quality of printing on the light guide plate is satisfactory so as to supervise, manage, and control the quality of the light guide plate.

According to a second aspect, the present invention further provides a display device including the light guide plate according to the technical solution above. Since the light guide plate has a high optical quality, the displaying quality of the display device will be high.

According to a second aspect, the present invention further provides a method for manufacturing a light guide plate, using the light guide plate according to any one of the technical solutions above, the manufacturing method including:

aligning in position the pattern printing section of the screen printing stencil with the light guide plate to be printed, using the at least one positioning mark hole; and

printing on the light guide plate to be printed, using the aligned screen printing stencil.

With the method above for manufacturing a light guide plate, as compared with the prior art, the precision of aligning in position the screen printing stencil with the light guide plate to be printed can be improved to thereby improve the optical quality of the light guide plate so as to improve the displaying quality of the display product.

### BRIEF DESCRIPTION OF THE DRAWINGS

In order to make the technical solutions according to the embodiments of the invention or in the prior art more apparent, the drawings to which a description of the embodiments or the prior art refers will be briefly introduced below, and apparently the drawings to be described below are merely illustrative of some of the embodiments of the invention, and those ordinarily skilled in the art can derive from these drawings other drawings without any inventive effort. In the drawings:

FIG. 1 is a schematic diagram of a screen printing stencil according to an embodiment of the invention;

FIG. 2 is a schematic diagram of a light guide plate manufactured using the screen printing stencil according to the embodiment of the invention illustrated in FIG. 1;

FIG. 3 is a schematic diagram of a screen printing stencil according to another embodiment of the invention;

FIG. 4 is a schematic diagram of a light guide plate manufactured using the screen printing stencil according to the embodiment of the invention illustrated in FIG. 3; and

FIG. 5 is a schematic flow chart of a method for manufacturing a screen printing stencil according to an embodiment of the invention

### REFERENCE NUMERALS

1—Pattern printing section

2—Light guide plate to be printed

3—Positioning mark hole

4—Positioning mark

5—Printed light guide plate

10—Pattern hole

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

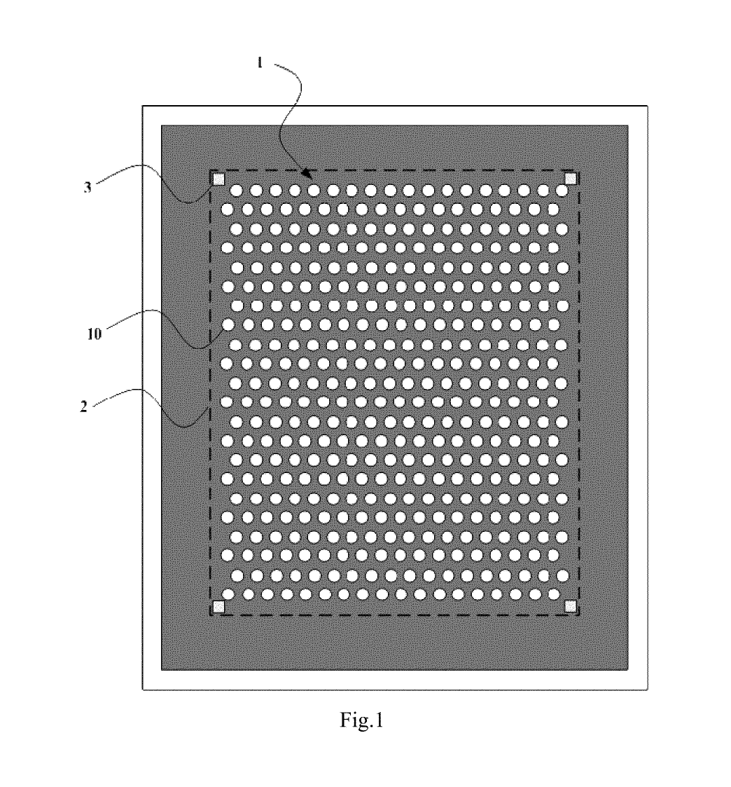

As illustrated in FIG. 1, a screen printing stencil according to an embodiment of the invention includes a pattern printing section 1 arranged corresponding to a light guide plate 2 to be printed, and at least one positioning mark hole 3 arranged on the peripheral of the pattern printing section 1.

The pattern printing section 1 of the screen printing stencil corresponds to the light guide plate 2 to be printed, and includes a number of pattern holes 10 which are optically designed. The light guide plate is manufactured by firstly aligning in position the pattern printing section 1 of the screen printing stencil with the light guide plate 2 to be printed, then coating printing oil on the screen printing stencil, and thereafter pressing the oil out of the pattern holes of the pattern printing section using a scraper of a printer to thereby form a corresponding pattern on the light guide plate to be printed.

In the prior art, it may be operationally difficult to position the screen printing stencil with respect to the light guide plate to be printed, and if they are positioned inaccurately, then the pattern may be displaced, thus degrading directly the optical characteristic of the display product, and the picture quality of the display product.

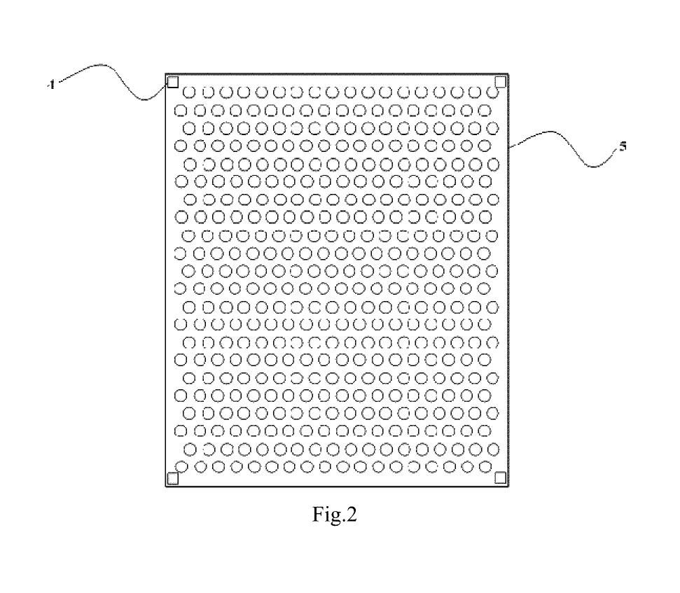

The light guide plate is manufactured using the screen printing stencil according to the embodiment of the invention by firstly aligning in position the pattern printing section 1 of the screen printing stencil with the light guide plate 2 to be printed, using the at least one positioning mark hole 3, and then printing on the light guide plate 2 to be printed. As illustrated in FIG. 2, a corresponding pattern of positioning marks 4 is printed on the light guide plate 5 in addition to the corresponding pattern. As compared with the prior art, the precision of aligning in position the screen printing stencil with the light guide plate to be printed can be improved to thereby improve the quality of displaying on the display product. Moreover the positioning mark pattern on the light guide plate can be observed to thereby determine whether the quality of printing on the light guide plate is satisfactory so as to supervise, manage, and control the quality of the light guide plate.

The number of positioning mark holes 3 will not be limited to any particular number, for example, the number of positioning mark holes can be one, two, or more. The positioning mark holes 3 will not be limited to any particular arrangement positions, for example, they can be positioned at the edges or corners of the pattern printing section 1. As illustrated in FIG. 1, in a preferred embodiment of the invention, there are four positioning mark holes 3 positioned respectively on four corners of the pattern printing section 1. A human operator observing the four positioning mark holes 3 can position precisely the screen printing stencil with respect to the light guide plate 2 to be printed.

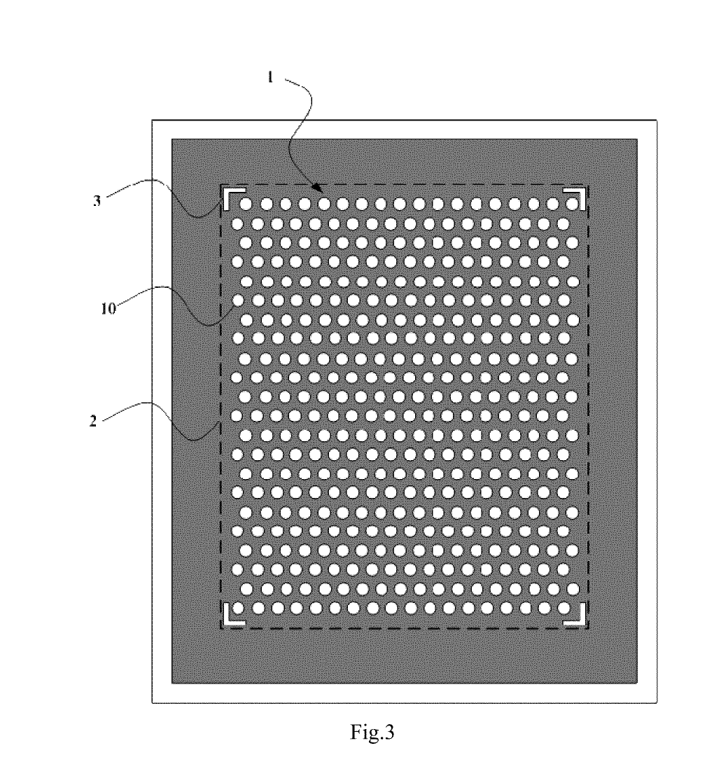

The positioning mark holes 3 will not be limited to any particular shape, for example, the positioning mark holes 3 can be rectangular positioning mark holes illustrated in FIG. 1, L-shaped positioning mark holes illustrated in FIG. 3, a right-angled triangular positioning mark holes, etc. Preferably there is a distance from 0.07 to 0.1 mm between the positioning mark holes 3 and the edges of the pattern printing section 1 to thereby facilitate operations by the human operating without compromising the design of the pattern holes 10.

An embodiment of the invention further provides a light guide plate manufactured using the screen printing stencil according to any one of the technical solutions above. Referring to FIG. 2 and FIG. 4, FIG. 2 is a schematic diagram of a light guide plate manufactured using the screen printing stencil according to the embodiment illustrated in FIG. 1, and FIG. 4 is a schematic diagram of a light guide plate manufactured using the screen printing stencil according to the embodiment illustrated in FIG. 3. Since the light guide plate being printed thereon is aligned in position precisely with the screen printing stencil, there will be a high optical quality of the light guide plate.

Moreover a pattern of the positioning marks 4 on the light guide plate can be observed to thereby determine whether the quality of printing on the light guide plate is satisfactory so as to supervise, manage, and control the quality of the light guide plate. For example, with the light guide plate manufactured using the screen printing stencil illustrated in FIG. 1 or FIG. 3, if there are less than four positioning marks, or the pattern of any one of the positioning marks is incomplete, then it can be determined that the screen printing stencil has not been positioned accurately with respect to the light guide plate to be printed, while the light guide plate is being printed thereon.

An embodiment of the invention further provides a display device including the light guide plate according to the technical solution above. Since the light guide plate has a high optical quality, the displaying quality of the display device will be high. The display device will not be limited to any particular type, for example, the display device can be a liquid crystal display, a liquid crystal TV set, a tablet PC, a mobile phone, etc.

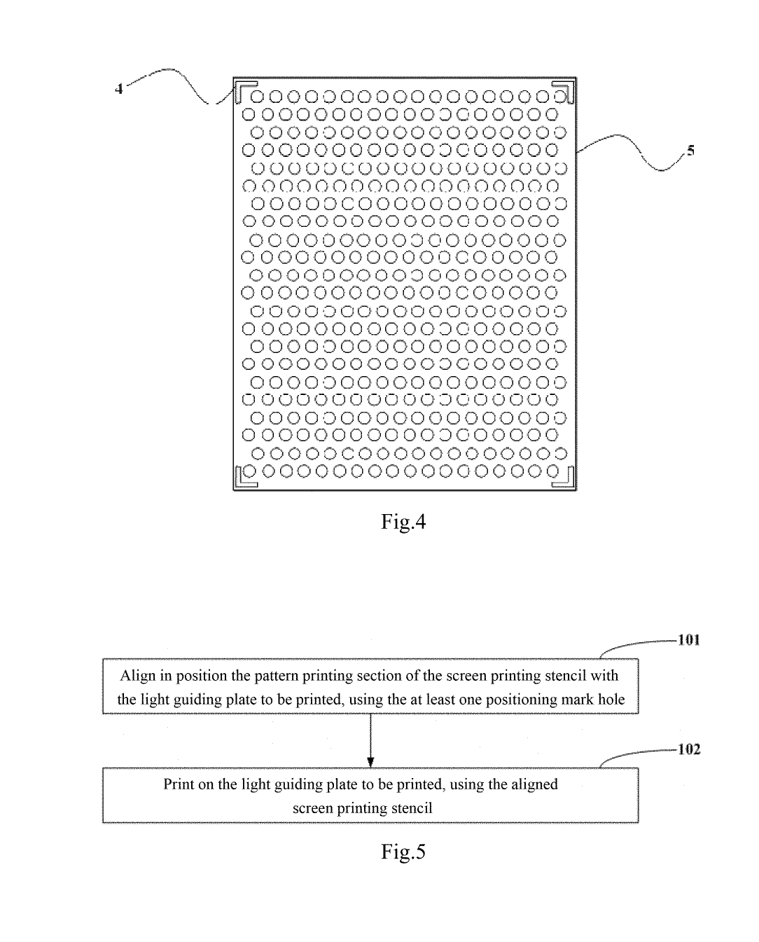

As illustrated in FIG. 5, an embodiment of the invention further provides a method for manufacturing a light guide plate, and the manufacturing method uses the screen printing stencil according to any one of the technical solutions above, where the manufacturing method includes:

The step 101 is to align in position the pattern printing section of the screen printing stencil with the light guide plate to be printed, using the at least one positioning mark hole; and

The step 102 is to print on the light guide plate to be printed, using the aligned screen printing stencil.

With the method above for manufacturing a light guide plate, as compared with the prior art, the precision of aligning in position the screen printing stencil with the light guide plate to be printed can be improved to thereby improve the optical quality of the light guide plate so as to improve the quality of displaying on the display product.

Those ordinarily skilled in the art can appreciate that all or a part of the steps in the method according to the embodiments described above can be performed by program instructing relevant hardware, where the program can be stored in a storage medium, and include several instructions to cause a device (e.g., a monolithic processor, a chip, etc.) or a processor to perform all or a part of the steps in the method according to the respective embodiments; and the storage medium includes a U-disk, a mobile hard disk, a Read Only Memory (ROM), a Random Access Memory (RAM), a magnetic disc, an optical disk, or any other medium which can store program codes.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the invention as claimed.

What is claimed is:

1. A screen printing stencil, comprising a pattern printing section arranged corresponding to a light guide plate to be printed, and at least one positioning mark hole arranged on the periphery of the pattern printing section.

2. The screen printing stencil according to claim 1, wherein there are four positioning mark holes positioned respectively on four corners of the pattern printing section.

3. The screen printing stencil according to claim 1, wherein there is a distance from 0.07 to 0.1 mm between the positioning mark hole and the edge of the pattern printing section.

4. The screen printing stencil according to claim 1, wherein the positioning mark hole is a rectangular positioning mark hole, an L-shaped positioning mark hole, or a right-angled triangular positioning mark hole.

5. A light guide plate, manufactured using the screen printing stencil according to claim 1.

6. A display device, comprising the light guide plate according to claim 5.

7. A method for manufacturing a light guide plate, the manufacturing method using the screen printing stencil according to claim 1, wherein the manufacturing method comprises:
aligning in position the pattern printing section of the screen printing stencil with the light guide plate to be printed, using the at least one positioning mark hole; and
printing on the light guide plate to be printed, using the aligned screen printing stencil.
